(19) United States
(12) Patent Application Publication
(10) Pub. No.: US 2015/0081992 A1
(43) Pub. Date: Mar. 19, 2015

(54) METHOD, DEVICE, AND SYSTEM FOR DATA STORAGE MANAGEMENT

(71) Applicant: Tencent Technology (Shenzhen) Company Limited, Shenzhen (CN)

(72) Inventor: Bing CAI, Shenzhen (CN)

(73) Assignee: Tencent Technology (Shenzhen) Company Limited, Shenzhen (CN)

(21) Appl. No.: 14/553,531

(22) Filed: Nov. 25, 2014

Related U.S. Application Data
(63) Continuation of application No. PCT/CN2014/072144, filed on Feb. 17, 2014.

(30) Foreign Application Priority Data
Jun. 24, 2013 (CN) 201310253815.6

(51) Int. Cl. G06F 12/12

(52) U.S. Cl. CPC G06F 12/121; G06F 2212/69
USPC 711/159

(57) ABSTRACT

The disclosure involves a method for saving data from webpages. The method can be realized through the following steps: when the request of saving data from a target webpage is received, whether assigned saving space is big enough for storing all the data from a target webpage is judged in the beginning; if the assigned saving space is not big enough to store all the data from the target webpage, estimate the number of page views of the current collection of webpages in the next pre-set circle and the current collection of webpages is correspondent to webpage data saved in the saving space; based on the estimated amount of page view, eliminate webpage data saved in the saving space in order to make the saving space have the ability to save all the webpage data of the collection of the webpages mentioned above; and then all the webpage data of the collection of the webpages mentioned above is saved in the space. The disclosure also provides a device for storing webpage data. The disclosure helps improving the efficiency of saving data and the utilization rate of the saved webpage data.

### CROSS-REFERENCE TO RELATED APPLICATIONS

This application is a continuation application of and claims priority under 35 U.S.C. § 119 and 35 U.S.C. § 365 to PCT Patent Application No. PCT/CN2014/072144, filed Feb. 17, 2014, which claims priority to a Chinese Patent Application No. 201310253815.6, filed Jun. 24, 2013, both of which are incorporated herein by reference in their entireties.

### FIELD OF THE TECHNOLOGY

The present disclosure is related to data storage, especially to website data storage management.

### BACKGROUND

With the speedy development of the Internet, the number of websites is increasing. And the content of website keeps updated. While the content of website keeps updated, some old webpages are still visited. Therefore, the amount of the total webpage data is increasing. No matter these webpages are served as a search engine or as a platform for gathering data, it is impossible to store all the webpage data in a limited saving space (such as magnetic disk and internal storage). As a result, it is of great importance to employ a good mechanism of eliminating webpage data in a saving space. In this mechanism, some old webpage data can be eliminated in the saving space in order to save some new webpage data. Currently, two common methods for managing webpage data storage treat all the webpages the same without considering the page views of different webpages and thus, are not very efficient.

### SUMMARY

In light of the above, the present disclosure provides a method, device and system for data storage management to improve the efficiency of storage and the utilization rate of the saved webpage data.

The method for managing a data storage device having a processor and a non-transitory storage accessible to the processor, comprises: determining, by the processor, whether there is enough storage space to store a target webpage in the non-transitory storage; if there is not enough space to store the target webpage in the data storage device, estimating, by the processor, number of page views of at least one collection of webpages at a future time based on historical numbers of page views of the at least one collection of webpages, wherein the at least one collection of webpages comprises a plurality of webpages currently stored in the non-transitory storage; and removing, by the processor, at least one webpage currently stored in the non-transitory storage based on the estimated numbers of page views. The present disclosure also provides a device for storing webpage data.

The device for saving webpage data comprises at least one processor, and a non-transitory storage medium accessible to the processor, the non-transitory storage medium is configured to store: a determination module configured to determine whether there is enough space to store a target webpage in the non-transitory storage medium; an estimation module configured to estimate number of page views of at least one collection of webpages at a future time, if there is not enough space to store the target webpage in the device, wherein the at least one collection of webpages comprises a plurality of webpages currently stored in the non-transitory storage medium; and a removal module configured to remove at least one webpage currently stored in the non-transitory storage medium based on the estimated numbers of page views at a future time.

The method provided by the present disclosure manages website data storage based on the estimated number of page views of at least one collection of webpages at a future time based on the corresponding historical numbers of page views of the collection of webpages that are currently saved in the storage. The present disclosure improves efficiency of data storage and the utilization rate of webpage data.

This section provides a general summary of the disclosure, and is not a comprehensive disclosure of its full scope or all of its features.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The accompanying drawings are included to provide a further understanding of the claims and disclosure, are incorporated in, and constitute a part of this specification. Apparently, the accompanying drawings in the following description are only some embodiments of the present disclosure, and persons of ordinary skill in the art may further derive other drawings according to these accompanying drawings without creative efforts.

FIG. 1 is a structural diagram of a server;

FIG. 2 is a flow chart of a first embodiment of a method for managing webpage data storage;

FIG. 3 is a detailed flow chart of the step S2 in the FIG. 2;

FIG. 4 is an example diagram illustrating a trend of the number of page views of a collection of webpages in one embodiment;

FIG. 5 is a detailed flow chart of the step S2.2 in the FIG. 3; and

FIG. 6 is a structural diagram of a device in a fourth embodiment of the present disclosure.

### DETAILED DESCRIPTION OF THE EMBODIMENTS

The various embodiments of the present disclosure are further described in details in combination with accompanying drawings and embodiments below. Like numbered elements in the same or different drawings perform equivalent functions. It should be understood that the specific embodiments described here are used only to explain the present disclosure, and are not intended to limit the present disclosure.

When describing a particular example, the example may include a particular feature, structure, or characteristic, but every example may not necessarily include the particular feature, structure or characteristic. This should not be taken as a suggestion or implication that the features, structure or characteristics of two or more examples, or aspects of the examples, should not or could not be combined, except when such a combination is explicitly excluded.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

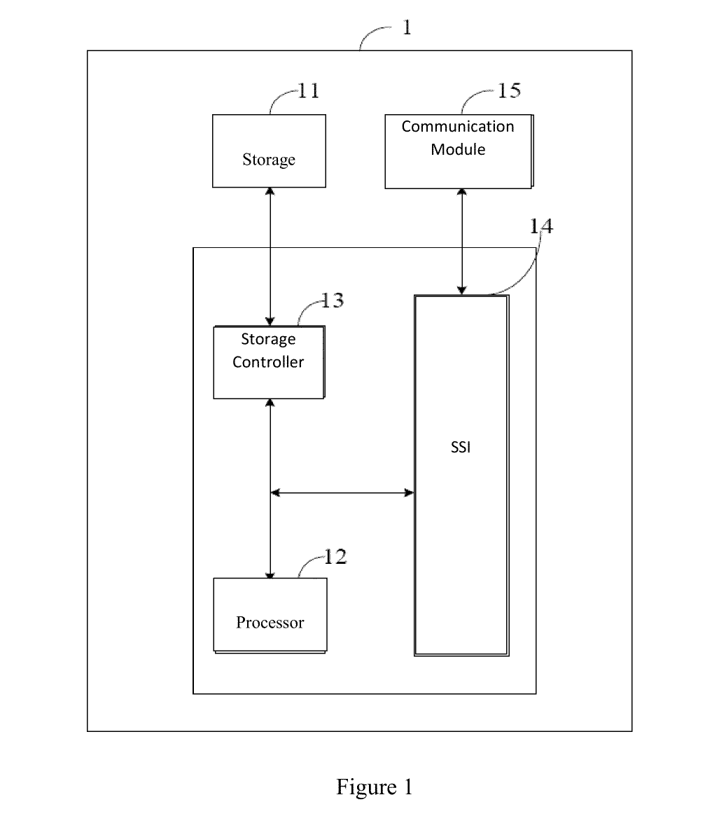

FIG. 1 is a structural diagram of a server. The server 1 can be a server which can be a group of servers or virtual cloud computing module. In one embodiment, the server 1 can include one (only one in the FIG. 1) or more storages, storage 11, storage 12, storage controller 13, SSI 14 and Communication Module 15. And the parts can be connected by one or more than one communication buses or signal lines.

General technical staff of the domain can understand that FIG. 1 is only an example of the structure, not to define the structure of the server 1. For instance, the server 1 can contain less or more parts than that shown on FIG. 1; or the server can contain different configuration from that of FIG. 1. The parts in FIG. 1 can use hardware, software or a combination of both hardware and software.

The storage 11 is used in the programs and modules of storage software, such as in program orders and modules correspondent to the methods and devices for managing website data in the embodiments of the disclosure. The server 12 can run the software programs and modules of the storage 11 to perform respective application of every function and to deal with data. The storage 11 can contain high-speed RAM and NVM, such as one or more magnetic storage device, flash memory and other Nonvolatile solid-state memory. In some embodiments, the storage 11 can further contain memories of remote settings correspondent to the processor 12. These memories of remote settings can connect to the server 1 through network connection. The network above includes the Internet, company intranet, LAN, mobile radio communication and a combination of the former four or the like. The visit of the processor 12 and other possible parts to the storage 11 can be done under the control of the storage controller 13.

The SSI 14 couples all the input and output devices to the processor 12 and the storage 11. The processor 12 runs all the software and orders of the storage 11 and performs all the functions and data processing of the server 1.

Communication Module 15 is used in communication network and configured to communicate with other devices. More specifically, the Communication Module 15 can be network card. Network card is served as a port in LAN, connecting computer and transmission media. Network card is configured to realize the physical connection and the matching of electrical signals with transmission media of LAN. By means of this, LAN is established and connected to the Internet, so the LAN can communicate with all types of network, such as LAN, MAN and WAN.

The server 1 can also contain Input Unit and Display Unit and so on and they are not shown in the figure and will not be explained again.

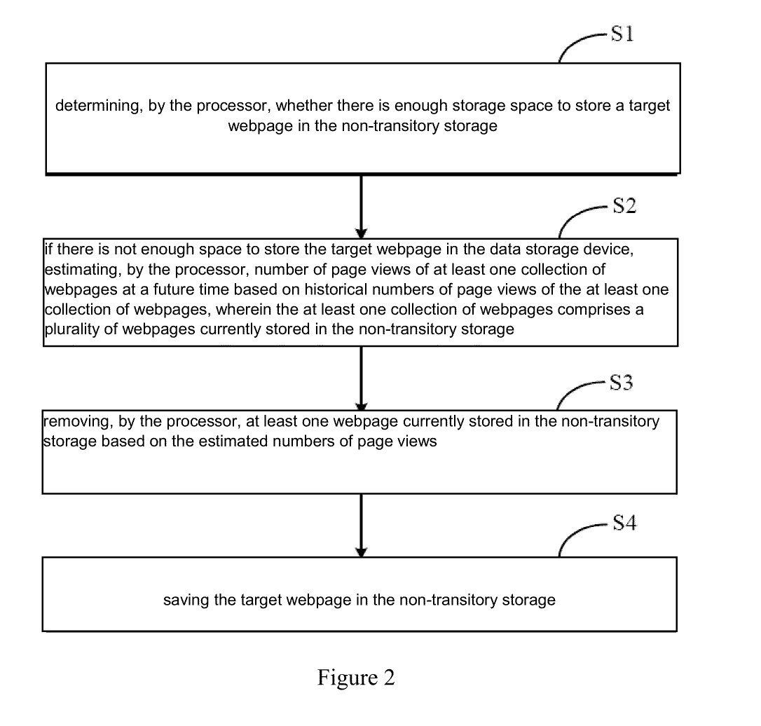

FIG. 2 is a flow chart of a first embodiment of a method for managing webpage data. The method for managing webpage data in the first embodiment can be applied in a server like Server 1 mentioned previously. The method comprises the following steps as listed below:

In S1, upon receiving a request of saving data from a target webpage, determining, by the processor, whether there is enough storage space to store a target webpage in an assigned storage space;

In S2, if the assigned storage space is not big enough to store all the data from the target webpage, estimating the number of page views (PV) of at least one collection of webpages at a future time, for example in a next pre-set circle, and the collection of webpages comprises a plurality of webpages currently stored in the storage;

In S3, based on the estimated number of page views, removing webpage data currently saved in the storage in order to make the saving space have the ability to save all the webpage data of the collection of the webpages mentioned above;

In S4, saving the target webpage in the storage.

A server, as used herein, may refer to one or more server computers configured to provide certain server functionalities, such as database management and search engines. A server may also include one or more processors to execute computer programs in parallel.

According to the method for managing webpage data mentioned above, based on the estimated number of page views of the webpage data of the collection of the current webpages in the next pre-set circle, the present disclosure helps obtain enough room to store new webpage data in order to improve the efficiency of data storage and the utilization rate of webpage data.

In some embodiments, the steps to realize the method above are explained in details as below.

The target collection of webpages in the S1 contains at least one pre-set webpage. The webpage data of the target collection of webpages indicate all the data from the target collection of webpages. In an embodiment, the target collection of webpages can be, for instance, the collection of newly generated webpages in a specified period of time, for example in one day, from one or more websites in the server 1 (such as news website, discussion website, and shopping website and so on). With the increasing number of newly generated webpages, the webpage data of the collection of newly generated webpages is saved to the storage 11 in the server 1 and such a request is sent. At the same time, the storage 11 is not the internal memory for temporary data storage. The storage 11 is the internal or external hard disk storage in the server 1 and the storage 11 is configured to store the webpage data for a long time. The saving space mentioned above indicates an assigned saving area with a fixed size in the hard disk storage.

In another embodiment, due to the advantage—fast access rate—of internal storage, and for the purpose of accelerating the rate of visiting the webpage data, when visiting the webpage data saved in the hard disk storage mentioned above in the server 1, the server 1 will read the webpage data in the hard disk storage and the webpage data is saved in the internal storage by the server 1 for the purpose of fast access. As a result, the webpage data of the target collection of webpages can be acquired from the hard disk storage, and before the webpage data is saved to the internal storage, the request of saving data is sent. The saving space indicates an assigned saving area with a fixed size in the hard disk storage in the server 1.

Specifically, in S1, whether assigned storage space is big enough for storing all the data from a target webpage is determined by comparing the size of the webpage data of the collection of webpages with the size of left room in the saving space. If the size of the webpage data of the collection of webpages is smaller than the size of left room in the saving space, it indicates that the storage space can store the webpage data of the collection of webpages. If the storage space is enough to store the webpage data of the collection of webpages, the webpage data of the collection of webpages is saved in the storage space.

In this embodiment, the collection of webpages correspondent to the webpage data saved to the storage space is called target collection of webpages. The collection of webpages correspondent to the webpage data currently saved to the storage space is called current collection of webpages. Every current collection of webpages contains at least one pre-set webpage.

In S2, the number of page views of the current collection of webpages in the next pre-set circle indicates that in the next pre-set circle, the summation of page view of every webpage from the current collection of webpages. The page view of every webpage refers to the times that the webpage is visited. For instance, when the webpage receives an HTML (Hypertext Markup Language) request from the browser, one time is added to the times of page view. The pre-set circle can be a circulatory period of time. Next pre-set circle may indicate a coming pre-set circle. Every day, if 0:00-23:59 is a pre-set circle, and the current time of today is 20:00, the coming pre-set circle is 0:00-23:59 of next day.

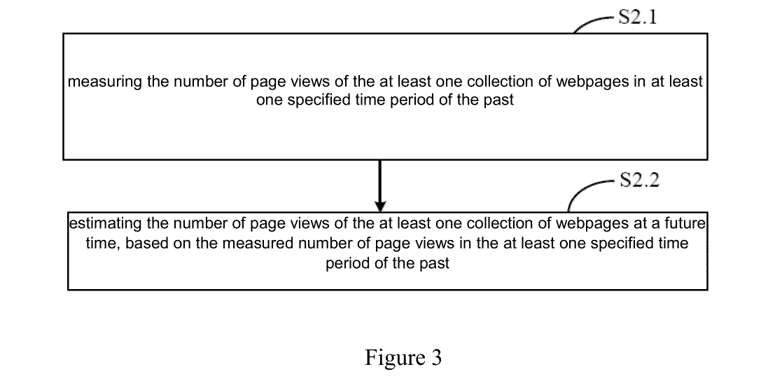

More specifically, as can be seen in the FIG. 3, estimating the number of page views of the current collection of webpages in the next pre-set circle can be realized through the following steps, and the current collection of the webpages is correspondent to webpage data currently saved in the storage space.

In S2.1, measuring the number of the page views of the current collection of webpages in at least one specified time period of the past, e.g. the past pre-set circles. In an embodiment, it is common that websites supervise the page view of webpages, therefore, in S2.1, the past page view of every webpage from the current collection of webpages is acquired in the beginning, and then the acquired page view of every webpage from the current collection of webpages is classified into the past different pre-set circles of the current collection of webpages based on time and websites.

In S2.2, based on the measured number of page views of the current collection of webpages in the at least one specified time period of the past, e.g. the past pre-set circles, estimating the number of page views of the at least one current collection of webpages at a future time, e.g. in the next pre-set circle.

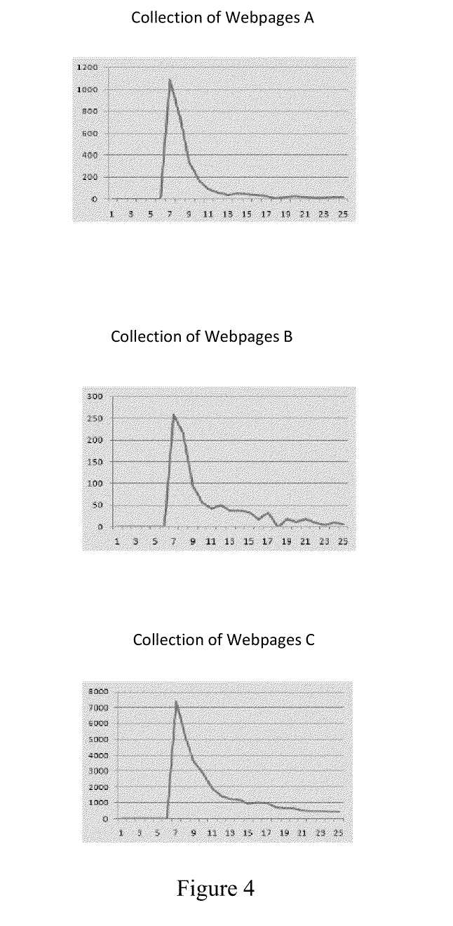

As can be seen from the previous statistics, although the number of page views which are related to the collections of webpages in the past pre-set circles are different, and the trends (the speed of increasing and deceasing) of page views of the current collection of webpages in the past pre-set circles are also different, generally speaking, the trends of page views of the collections of webpages in the past pre-set circles approximately matches a power law distribution. This is illustrated in FIG. 4. A power law distribution herein refers to a distribution by a power function. The power function indicates the function which matches the equation y=cx^{-r}. In the power function, base number is an independent variable and power is a dependent variable; exponent is constant. In the power function, because the parameters c and r are different, power law distribution is also different and power law distribution correspondent to the trend of page views which are related to the current collection of webpages in the past pre-set circles is also different. Therefore, if the distribution function which reflects the trend of page view which is related to the current collection of webpages is calculated, the number of page views which is related to the current collection of webpages in the next pre-set circle can be estimated.

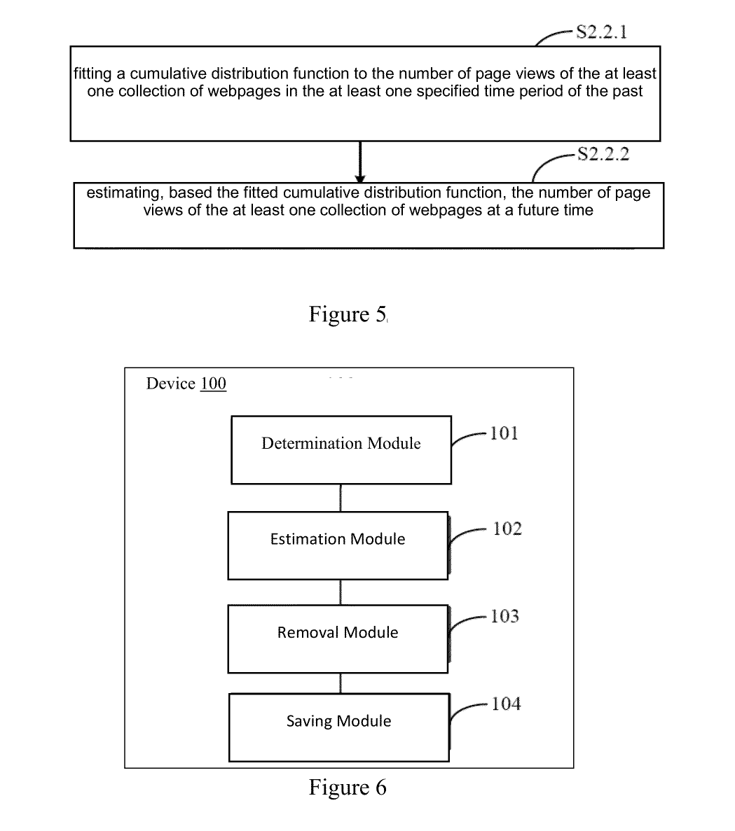

As shown in FIG. 5, S 2.2 can be further divided into the following steps:

S2.2.1 is a step of fitting a cumulative distribution function to the number of page views of the at least one collection of webpages in the at least one specified time period of the past. The cumulative distribution function can be a power function. Alternatively, the distribution function may also be a probability density function or functions the like in other embodiments, as long as the function reflects the trend of page views which is related to the current collection of webpages.

Specifically speaking, the fitting mentioned above indicates several discrete function values {f1, f2, . . . , fn} of a certain function. Through adjusting several undetermined coefficients f(λ1, λ2, . . . , λn) in the discrete function, this lessens the distinction between the function and the already know point set. In this embodiment, through least square method, the parameters c and r in the distribution function of the trend of page views which is related to the current collection of webpages can be calculated. After this, the distribution function of the trend of page views which is related to the current collection of webpages can be calculated. A preferred function fitting can be found by means of least squares method. The least squares method indicates minimizing error sum of squares. In this way, unknown value can be calculated and the error sum of squares between the unknown value calculated and the real value can be minimized.

Based on the respective cumulative distribution function, estimate the number of page views of the current collection of webpages in the next pre-set circle.

In S3, in one embodiment, the webpage data saved in the saving space and the webpage data correspondent to the current collection of webpages with the number of page views which is less than the pre-set threshold value is eliminated in order to make the saving space big enough to store the webpage data of the target collection of webpages. The pre-set threshold value can be set according to former experience. The pre-set threshold value can contain several sub-threshold values, such as threshold 1 and threshold 2 and so on. The webpage data correspondent to the current collection of webpages with the number of page views which is less than the pre-set first threshold is eliminated. If the saving space is still not big enough to store the webpage data of the target collection of webpages, the webpage data correspondent to the current collection of webpages with the number of page views which is less than the pre-set second threshold is eliminated, and so forth, until the saving space is big enough to store the webpage data of the target collection of webpages. The first threshold is less than the second threshold.

In S4, all the webpage data of the target collection of the webpages mentioned above is saved in the space when the saving space is big enough to store the webpage data of the target collection of the webpages.

To provide more ways of removing webpage data from the saving space in the S3 of the embodiment 1, and to make the removal of webpage data from the storage space more flexible, compared with the method for managing webpage data in the first embodiment, S3 can be realized through the following steps:

Ranking the number of page views from low to high and the number of page views is related to the current collection of webpages correspondent to webpage data saved in the saving pace; based on the ranking of the number of page views, remove some webpage data of the collection of the current webpages. The removed webpage data is the data of some current webpages with higher rank. After the elimination of some webpage data of the collection of the current webpages with higher rank, the saving space is not big enough to store the webpage data of the target collection of the webpages, the same elimination can be performed again until the saving space is big enough to store the webpage data of the target collection of the webpages.

The method for saving webpage data in the embodiment is related to the S3 which is a step of the method for managing webpage data in the first embodiment. The method in the embodiment 2 is more flexible, and further improves the storage efficiency of webpage data and the utilization rate of webpage data saved in the saving space.

To provide more ways of eliminating webpage data from the saving space in the S3 of the embodiment 1, and to make the elimination of webpage data from the saving space more flexible, compared with the method for saving webpage data in the first embodiment, S3 can be realized through the following steps:

Based on the ranking of the number of page views, removing some webpage data of the current collection of webpages until the storage space is big enough to save the webpage data of the collection of the current webpages. The eliminated webpage data is the data of some current webpages with a low number of page views. In other words, the webpage data with the smallest number of page views is removed at first. If the saving space is still not big enough to store the webpage data of the target collection of webpages, and based on this principle, other webpage data is removed until the saving space is still big enough to store the webpage data of the target collection of webpages.

The method for saving webpage data in the embodiment is related to the S3 which is a step of the method for saving webpage data in the first embodiment. The method in the embodiment 3 is more flexible, and further improves the storage efficiency of webpage data and the utilization rate of webpage data saved in the saving space.

As can be seen in the FIG. 6, a fourth embodiment provides a device, 100, for saving webpage data and the device 100 is used in the server 1. The device 100 for saving webpage data consists of Determination Module 101, Estimation Module 102, Removal Module 103 and Saving Module 104. The modules above indicate computer programs or chunks of computer programs which are configured to perform one or more specific functions. The modules are individual in the embodiment; however, this does not indicate that in practical use, computer programs or chunks of computer programs are individual.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term “module” may include memory (shared, dedicated, or group) that stores code executed by the processor.

Determination Module 101, it is configured to judge whether assigned saving space is big enough for storing all the data from target webpages when the request of saving data from a target webpage is received. If the assigned saving space is big enough for storing all the data from target collection of webpages, the step 104 of saving data is performed.

Estimation Module 102, the function of which is that if the assigned saving space is not big enough to store all the data from the target webpage, the Estimation Module estimates the number of page views of the current collection of webpages in the next pre-set circle and the current collection of webpages is correspondent to webpage data saved in the saving space.

Specifically speaking, the Estimation Module 102 counts the number of the page views of the current collection of webpages in the past pre-set circles respectively at first. And based on the counted number of the page views, the respective cumulative distribution function of the number of page views which is related to the current collection of webpages is calculated. And then based on the respective cumulative distribution function, estimate the number of page views of the current collection of webpages in the next pre-set circle.

Removal Module 103, its function is that based on the estimated number of page views, the Removal Module eliminates webpage data saved in the saving space in order to make the saving space have the ability to save all the webpage data of the collection of the webpages mentioned above; the distribution function can be acquired through least squares fit.

In one embodiment, in Removal Module 103, the webpage data saved in the saving space and the webpage data correspondent to the current collection of webpages with the number of page views which is less than the pre-set threshold is eliminated in order to make the saving space big enough to store the webpage data of the target collection of webpages.

In one embodiment, in Removal Module 103, rank the number of page views from low to high and the number of page views is related to the current collection of webpages correspondent to webpage data saved in the saving pace; based on the ranking of the number of page views, eliminate some webpage data of the collection of the current webpages. The eliminated webpage data ranks in the front. The same elimination can be performed again until the saving space is big enough to store the webpage data of the target collection of the webpages.

In another embodiment, in Removal Module 103, based on the ranking of the number of page views, eliminate some webpage data of the current collection of webpages until the saving space is big enough to save the webpage data of the collection of the current webpages.

Saving Module, it is configured to save the webpage data of the current collection of webpages in the saving space.

With regard to the specific process of working of the modules above, the first, second and third embodiments of the disclosure provide some methods for saving webpage data. These methods can be used as reference. And these methods will not be explained again.

In conclusion, the device 100 for saving webpage data in the embodiments, based on the number of page views in the next pre-set circle, which is related to the webpage data of the collection of the current webpages, the disclosure helps the saving space to have enough room to store new webpage data in order to improve the efficiency of data storage and the utilization rate of webpage data.

In addition, the embodiments of the disclosure also provide a computing readable storage medium the internal memory of which can perform orders. The computing readable storage medium can be optical disk, hard disk or flash memory. The computer can perform orders to let the computer or similar computing device to complete the all the operations above of saving webpage data.

The embodiments above are only some preferred embodiments. They are not to define the disclosure. Although some preferred embodiments of the disclosure are explained above, they are not to define the disclosure. Any technical staff of the domain can take advantage of the embodiments above to make equal improvements and adjustments within the technical scheme of the disclosure. If these equal improvements and adjustments are within the range of the technical scheme of the disclosure, any improvements and adjustments with equal effects are protected by the patent of the disclosure.

What is claimed is:

1. A method for managing a data storage device having a processor and a non-transitory storage accessible to the processor, comprising:
determining, by the processor, whether there is enough storage space to store a target webpage in the non-transitory storage;
if there is not enough space to store the target webpage in the data storage device, estimating, by the processor, number of page views of at least one collection of webpages at a future time based on historical numbers of page views of the at least one collection of webpages, wherein the at least one collection of webpages comprises a plurality of webpages currently stored in the non-transitory storage; and
removing, by the processor, at least one webpage currently stored in the non-transitory storage based on the estimated numbers of page views.

2. The method of claim 1, further comprising:
obtaining, by the processor, available storage space freed by the removed at least one webpage, so that there is enough available storage space to store the target webpage; and
saving the target webpage in the non-transitory storage.

3. The method of claim 2, wherein the estimating number of page views of the at least one collection of webpages at a future time based on historical numbers of page views of the at least one collection of webpages, further comprises:
measuring the number of page views of the at least one collection of webpages in at least one specified time period of the past; and
estimating the number of page views of the at least one collection of webpages at a future time, based on the measured number of page views in the at least one specified time period of the past.

4. The method of claim 3, wherein the estimating the number of page views of the at least one collection of webpages at a future time, based on the measured number of page views in the at least one specified time period of the past, further comprises:
fitting a cumulative distribution function to the number of page views of the at least one collection of webpages in the at least one specified time period of the past; and
estimating, based the fitted cumulative distribution function, the number of page views of the at least one collection of webpages at a future time.

5. The method of claim 4, wherein the fitting the cumulative distribution function to the number of page views of the at least one collection of webpages in the at least one specified time period of the past, comprises fitting an exponential distribution using least squares.

6. The method of claim 1, wherein the removing at least one webpage currently stored in the non-transitory storage based on the estimated numbers of page views, further comprises
removing at least one webpage of the at least one collection of webpages from the non-transitory storage, when the estimated number of page views at a future time is less than a threshold value.

7. The method of claim 1, wherein the removing at least one webpage currently stored in the non-transitory storage based on the estimated numbers of page views, further comprises:
ranking the at least one collection of webpages based on corresponding numbers of page views of the collection of webpages in at least one specified time period at a future time, from the lowest to highest; and
removing a specified amount of webpage data from the ranked first collection of webpages, until there is enough storage space to store the target webpage.

8. The method of claim 7, wherein the removing, by the processor, at least one webpage currently stored in the non-transitory storage based on the estimated numbers of page views, further comprises:
removing at least one webpage from the collections of webpages in an order of their rankings until there is enough space to store the target webpage data.

9. The method of claim 1, wherein after determining whether there is enough space to store a target webpage in the non-transitory storage, the method further comprises:
saving the target webpage, if there is enough space to store the target webpage in the non-transitory storage.

10. A device, comprising at least one processor and a non-transitory storage medium accessible to the processor, the non-transitory storage medium is configured to store the following modules implemented by the processor:
a determination module configured to determine whether there is enough space to store a target webpage in the non-transitory storage medium;
an estimation module configured to estimate number of page views of at least one collection of webpages at a future time, if there is not enough space to store the target webpage in the device, wherein the at least one collection of webpages comprises a plurality of webpages currently stored in the non-transitory storage medium; and
a removal module configured to remove at least one webpage currently stored in the non-transitory storage medium based on the estimated numbers of page views at a future time.

11. The device according to claim 10, wherein device further comprising a saving module configured to
obtain available storage space freed by the removed at least one webpages, so that there is enough available storage space to store the target webpage; and
save the target webpage in the non-transitory storage medium.

12. The device according to claim 10, wherein the estimation module is further configured to:
measure the number of page views of the at least one collection of webpages in at least one specified time period of the past; and
estimate the number of page views of the at least one collection of webpages at a future time based on the measured number of page views of the at least one collection of webpages in the at least one specified time period of the past.

13. The device according to claim 12, wherein the estimation module is further configured to:
fit a cumulative distribution function to the number of page views of the at least one collection of webpages in the at least one specified time period of the past; and
estimate, based the fitted cumulative distribution function, the number of page views of the at least one collection of webpages at a future time.

14. The device according to claim 13, wherein the estimation module is further configured to fit an exponential distribution using least squares.

15. The device according to claim 10, wherein the removal module is further configured to:
remove at least one webpage of the at least one collection of webpages from the non-transitory storage medium, when the estimated number of page views at a future time is less than a threshold value.

16. The device according to claim 10, wherein the removal module is further configured to:
rank the at least one collection of webpages based on corresponding numbers of page views of the collection of webpages in at least one specified time period at a future time, from the lowest to highest; and
remove a specified amount of webpage data from the ranked first collection of webpages, until there is enough storage space to store the target webpage.

17. The device according to claim 16, wherein the removal module is further configured to:
remove at least one webpage from the collections of webpages in an order of their rankings until there is enough space to store the target webpage data.

18. The device according to claim 11, wherein the saving module is further configured to save the target webpage, if there is enough space to store the target webpage in the non-transitory storage medium.

19. A non-transitory computer-readable storage medium comprising a set of instructions for compositing sequential images, the set of instructions to direct at least one processor to perform acts of:
determining whether there is enough storage space to store a target webpage in the non-transitory storage;
if there is not enough space to store the target webpage in the data storage device, estimating the number of page views of at least one collection of webpages at a future time based on historical numbers of page views of the at least one collection of webpages, wherein the at least one collection of webpages comprises a plurality of webpages currently stored in the non-transitory storage; and
removing at least one webpage currently stored in the non-transitory storage based on the estimated numbers of page views.

20. The non-transitory computer-readable storage medium according to claim 19, wherein the set of instructions, when executed, further cause the processor to perform the act of:
obtaining available storage space freed by the removed at least one webpage, so that there is enough available storage space to store the target webpage; and
saving the target webpage in the non-transitory storage medium.

21. The non-transitory computer-readable storage medium according to claim 19, wherein the set of instructions, when executed, further cause the processor to perform the act of:
measuring the number of page views of the at least one collection of webpages in at least one specified time period of the past; and
estimating the number of page views of the at least one collection of webpages at a future time, based on the measured number of page views in the at least one specified time period of the past.

22. The non-transitory computer-readable storage medium according to claim 19, wherein the set of instructions, when executed, further cause the processor to perform the act of:
fitting a cumulative distribution function to the number of page views of the at least one collection of webpages in the at least one specified time period of the past; and
estimating, based the fitted cumulative distribution function, the number of page views of the at least one collection of webpages at a future time.

23. The non-transitory computer-readable storage medium according to claim 19, wherein the set of instructions, when executed, further cause the processor to perform the act of
fitting an exponential distribution using least squares to the number of page views of the at least one collection of webpages in the at least one specified time period of the past.

24. The non-transitory computer-readable storage medium according to claim 19, wherein the set of instructions, when executed, further cause the processor to perform the act of
removing at least one webpage of the at least one collection of webpages from the non-transitory storage medium, when the estimated number of page views at a future time is less than a threshold value.

25. The non-transitory computer-readable storage medium according to claim 19, wherein the set of instructions, when executed, further cause the processor to perform the act of
ranking the at least one collection of webpages based on corresponding numbers of page views of the collection of webpages in at least one specified time period of the past, from the lowest to highest; and
removing a specified amount of webpage data from the ranked first collection of webpages, until there is enough storage space to store the target webpage.

26. The non-transitory computer-readable storage medium according to claim 25, wherein the set of instructions, when executed, further cause the processor to perform the act of
removing at least one webpage from the collections of webpages in an order of their rankings until there is enough space to store the target webpage data.

27. The non-transitory computer-readable storage medium according to claim 20, wherein the set of instructions, when executed, further cause the processor to perform the act of
saving the target webpage, if there is enough space to store the target webpage in the non-transitory storage medium.
